(19) United States
(12) Patent Application Publication
(10) Pub. No.: US 2010/0266974 A1
(43) Pub. Date: Oct. 21, 2010

(54) Apparatus for preheating particulate material

(75) Inventor: Charles R. Euston, Hamburg, PA (US)

Correspondence Address: Daniel DeJoseph;FLSmidth Inc., 2040 Avenue "C", Bethlehem, PA, 18017, US

(73) Assignee: FLSmidth Inc.

(21) Appl. No.: 12/386,287

(22) Filed: Apr. 16, 2009

(51) Int. Cl. F27D 3/04

(52) U.S. Cl. 432/239

(57) ABSTRACT

A preheating apparatus for particulate material comprises a containment vessel, a floor ending in a central material discharge section, and a vertically oriented outer annular preheating section which circles the center section, with said annular preheating section having an outer wall and an inner wall having a lower side that is spaced above the floor to form an arch. A ram-type plunger feeder moves reciprocally from a first retracted position located closer to the outer wall to a second extended position located between the first retracted position and the material outlet of the chamber for contacting particulate material with said pusher face and moving particulate material under the arch and toward the material outlet. It has been discovered that in preheaters of this design the relative locations of the first retracted position of the feeder, the arch and the end of the sloped floor adjacent to the central discharge will have an influence on the movement of the particulate material toward the central discharge.

### BACKGROUND OF THE INVENTION

This invention relates to a method and apparatus for preheating and precalcining particulate material and, more particularly, to an improved method and apparatus for more efficiently preheating particulate material than is typically achieved utilizing conventional methods and apparatus.

Although the present invention is applicable generally to the preheating of particulate material, it is particularly applicable to the preheating and precalcining of limestone by flowing the limestone and the hot kiln gases from the calcining kiln in countercurrent heat exchange relationship to each other in an annular shaft preheating and precalcining apparatus.

A preheating and precalcining apparatus for particulate material typically comprises a containment vessel having a floor with a central discharge section. A vertically oriented annular preheating section having an upper and lower area is within the containment vessel and circles the center section. The annular preheating section has an outer wall, which typically also serves as the outer wall of the containment vessel, and an inner wall, said inner wall having a lower side that is spaced above the floor to form an arch. The annular preheating section can be further subdivided by one or more walls that extend from the outer wall to the inner wall. The center section of the floor falls off into a material outlet for discharging preheated particulate material out of the apparatus. There is a material inlet located toward the top of the annular preheating section for receiving particulate material into the section, a gas inlet toward the bottom of the annular preheating section for receiving hot kiln gas into the annular preheating section, a gas exhaust toward the top of the annular preheating section for discharging gas from the annular preheating section after the gas has passed through the particulate material in the section. The preheating apparatus also comprises at least one and preferably a plurality of ram plunger feeders each having a leading pusher face that comes into contact with the particulate material. The plunger feeder, which is located adjacent to or is in contact with the floor, is essentially reciprocally movable from a first retracted position located close to the outer wall of the annular preheating section to a second extended position located away from the outer wall and toward the material outlet of the chamber for contacting the preheated particulate material and moving it under the arch and toward the central material outlet.

In a typical apparatus for preheating and precalcining limestone, the limestone is supplied to an overhead storage bin and is directed downwardly whereupon it eventually passes through the annular preheating and precalcining passage to the floor of the preheater, which has a downward slope toward a central material discharge. The material thereafter moves to the central discharge where it falls into a calcining kiln. The annular preheating passage has an outer wall which typically also functions as the outer wall of the preheater and an inner wall which has a lower side or edge that is spaced a predetermined distance apart from and above the sloped floor. Hot gases from the kiln flow in countercurrent heat exchange relation and pass under the arch on the inner wall of the annular passage corresponding to the point where the inner wall ends and located a predetermined distance above the stone floor from which the hot gases penetrate into at least the lower region of the annular preheating and precalcining passage and flow in counter current relation to the flow of the limestone before exhausting from the preheating apparatus.

Material pushing ram feeders push the material down the sloped floor to the central discharge. The area of the floor starting directly underneath the arch and extending to the material outlet is also called the “hearth area” or “hearth” of the annular preheater. The material is pushed uniformly by the reciprocating motion of the rams that are typically actuated in a predetermined sequence. The rams typically have a rectangular boxed shape. The sequence of operation of each ram can be electronically controlled to move inwardly down the sloped floor, pushing the preheated and precalcined limestone toward the central discharge.

The typical dimensions of the area under the arch extending out to the material outlet influences the flow of material toward the outlet, with other factors, such as the material's angle of repose, coming into play. In the prevalent design of preheaters, the material being transported develops a dead area that extends almost the length of the hearth to the material outlet resulting in the stone motivated by the pusher ram to in effect be forced through a small area near the arch. This is called extruded flow, and it causes the preheater to be more inefficient in that
1. The dead area becomes hard and starts a progressive build-up reducing production and plant availability.
2. Much more pressure must be exerted by the pusher ram to move the stone though a small opening. This increased pressure crushes the stone and generates deleterious fines.
3. The extruded stone movement has an upward component which in certain cases can lift the arch and roof.

It is therefore an object of this invention to have a preheater in which the propensity for extruded flow of the preheated material is reduced or eliminated.

### SUMMARY OF THE INVENTION

The present invention is an improved apparatus for preheating particulate material that achieves the above object and other novel features.

In the present invention non-extruded, i.e. “en masse” flow, of particulate material under the preheater arch is promoted by a preheater in which there is a specific dimensional relationship between (a) the length of the floor (which may or may not be sloped) when said length is measured from the front, i.e. leading face, of the pusher ram when in a retracted position to the material outlet and (b) the straight line distance from the arch to the front, i.e. the leading face, of the pusher ram.

For a complete understanding of the present invention, reference can be made to the detailed description which follows and to the accompanying drawings, in which:

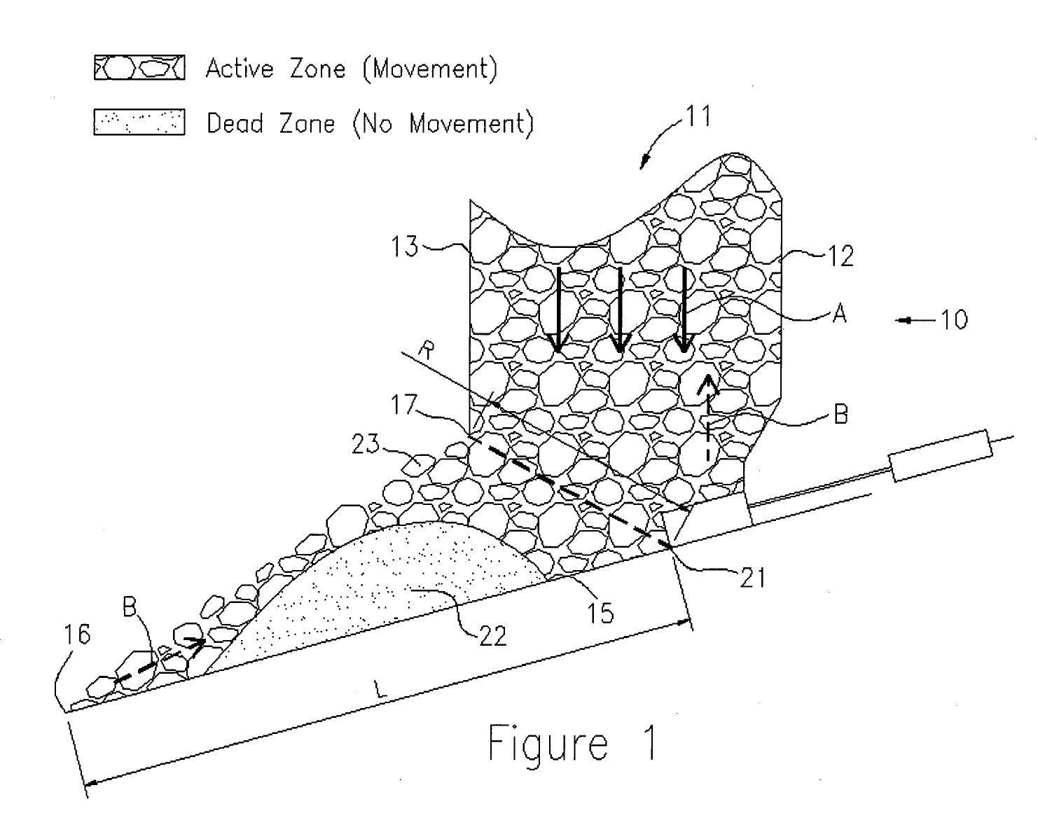

FIG. 1 is a cross-sectional vertical view of a portion of the annular preheating section of a prior art preheater;

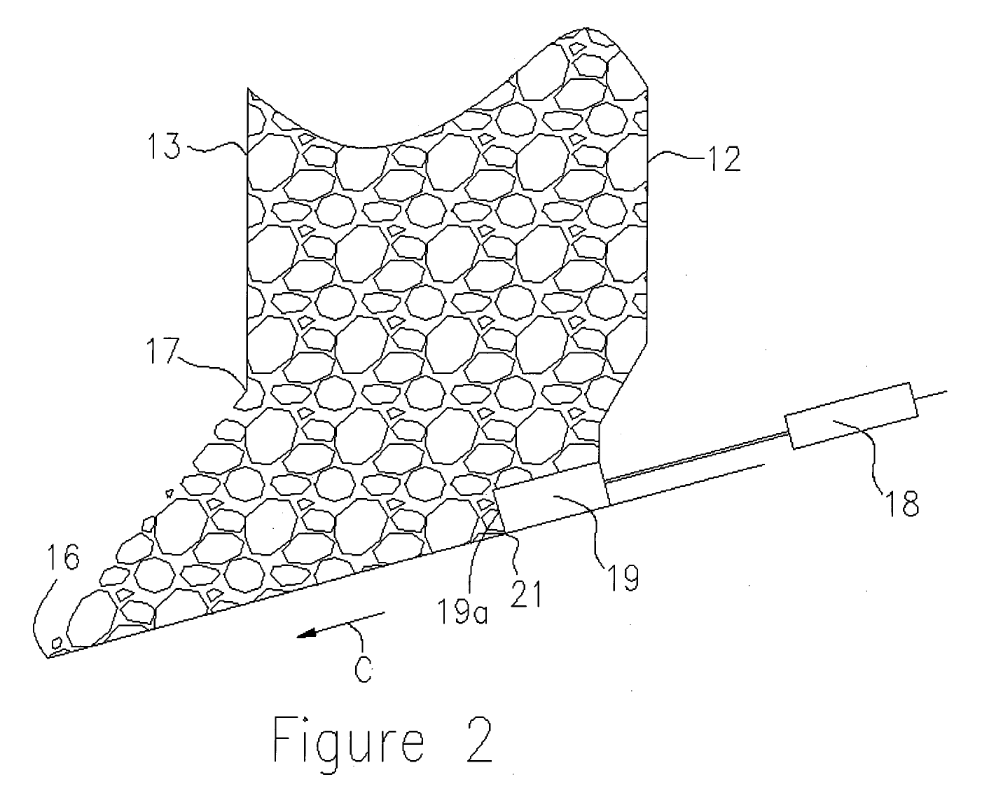

FIG. 2 is a cross-sectional vertical view of a portion of the annular preheating section of a preheater of the present invention;

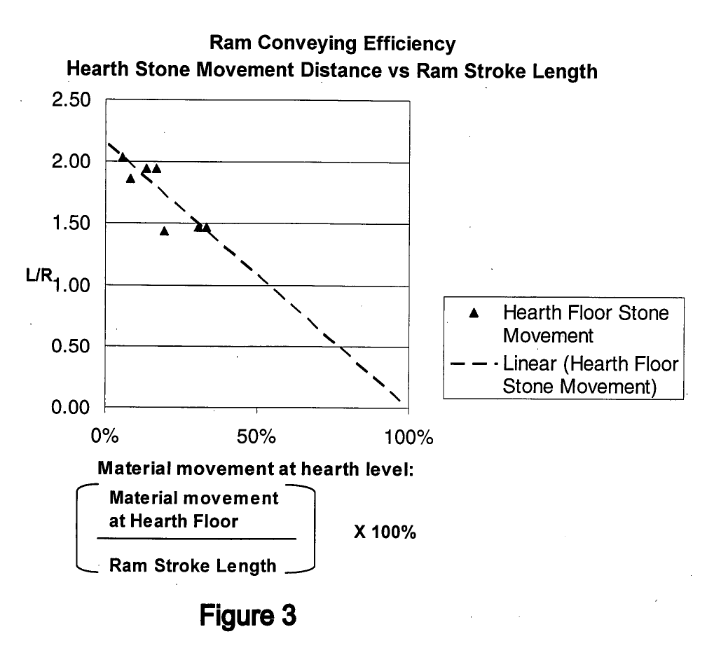

FIG. 3 is a diagram illustrating preheater dimensions that can to varied to achieve the purposes of this invention.

With reference to FIGS. 1 and 2, there is depicted a portion 10 of a prior art preheater and precalciner and most primarily a portion of annular stone passageway 11 bounded by outer wall 12 (which corresponds to the outer wall of the containment vessel of the preheater) and inner wall 13. The preheater is typically cylindrical but can be rectangular, and the annular passageway may be subdivided into vertically extending compartments or chimneys by one or more radially extending walls (not shown) that extend from outer wall 12 to inner wall 13.

Particulate material flows downwardly through the annular passageway 11 in the direction of arrows A from which it travels over a floor 15 which ends at a centrally located discharge area 16 from which the stone falls by gravity into a calcining kiln (not shown). Inner wall 13 has a bottom edge corresponding to arch 17 which is located above floor 15. Particulate material flows underneath arch 17 toward the discharge area 16.

Preheating hot kiln gas flows upward through the annular passageway 11 in countercurrent flow in the direction of arrows B to preheat and precalcine the particulate material prior to its discharge from the preheater into a limestone calcining kiln which is the source of the preheating hot gas utilized in the preheater.

There is at least one and preferably a plurality of material pusher ram feeders 19 having a front edge 19a that engages and propels particulate material to the material outlet 16. The pusher ram is reciprocally movable between a retracted position, which is the position illustrated in FIGS. 1 and 2, and an extended position when the pusher ram is fully extended by moving in the direction of arrow C toward the material outlet 16.

Each pusher ram 19 is driven by an actuator (not shown) and a hydraulic cylinder 18. When hydraulic cylinder 18 is activated, the corresponding pusher ram 19 moves inwardly in direction C pushing the preheated and precalcined limestone toward the discharge outlet 16 for transfer to the rotary kiln.

In current preheater designs there is a tendency for the limestone to develop a dead zone 22 located comparatively close to the outlet area 16 within which there is little or no stone movement. This dead zone develops primarily in the hearth area. In effect material has to be pushed over and around the dead zone to cause the stone thus motivated by the ram to in effect be forced through a small area 23 near arch 17. Moving a comparatively large amount of stone through a comparatively small passageway is referred to as “extruded flow” stone movement. In such a case, movement of stone through the preheater is held up by the dead zone. It is therefore desirable that extruded flow be curtailed to the extent possible and therefore ideally the particulate material should flow in en masse fashion through the preheater.

According to the present invention there is a preheater having a novel new design in the vicinity of the arch area which decreases the tendency toward extruded flow of particulate material in the hearth area of the preheater by countering the tendency of the preheater to form dead zones in the hearth area.

Specifically (with reference to FIG. 3), the preheaters of the present invention have the ratio of L/R is equal to or less than about 2.15, when

L=the straight distance from point 21 (which is at the bottom of the front edge of the pusher ram where it meets or is adjacent to sloped floor 15 when the pusher ram is in a retracted position) to point 16 (the end of the sloped floor, i.e. the point where the sloped floor drops off into the central discharge) to

R=the straight line distance from point 21 to arch 17.

In prior art annular shat preheaters the ratio of L/R is typically about 2.5 and above.

It has been discovered that when L/R is about 2.15 or more there will be a tendency for extruded material flow within the preheater. Values of L/R below about 2.15 will result in enmasse stone movement through the preheater.

FIG. 2 illustrates a preheater of the present invention which no dead zones of material flow are detected. The ratio of L/R in the preheated depicted in FIG. 2 is approximately 1.6.

The preferred range of the ratio of L/R to greatly reduce or eliminate the propensity of extruded flow within the preheater will be from about 0.25 to about 2.15, and the most preferred range will be from about 1.0 to about 2.0.

With reference to FIG. 3, presented are results of full scale experiments to investigate enmasse vs extruded flow regimes. During the experiments, different L/R geometries, as described above, were tested.

In each trial the ram was extend a prescribed distance forward from point 21 towards point 16. A measuring devise was embedded in the stone bed on the hearth floor near point 16. Extruded flow was indicated when the measuring device on the hearth flow near point 16 showed no movement after the ram was extended. En masse flow was indicated when the measuring device on the hearth floor near point 16 showed movement. The ratio of stone movement distance on the hearth floor near point 16 to the prescribed forward (towards point 16) ram movement from point 16 is represented by the x-axis in FIG. 3. This ratio of stone movement distance is correlated to the L/R ratio, which is represented on the y-axis in FIG. 3.

As one example of advantages inherent to the en masse flow, the slope of the floor can be reduced, which is advantageous in that the desired L/R ratio can be achieved with the shortest hearth length. One of the reasons a floor is deployed in prior art preheaters that is sloped toward the material outlet is to use gravity to help overcome the flow resistance resulting from the dead zones. For example, in the prior art preheaters the sloped floor will be at an angle ranging from between about 3° to 8° from the horizontal, and while in the preheater of the present invention standard sloped floors can be utilized, sloped floors at an angle from about 3° from the horizontal to essentially horizontal floors can be utilized. In the preheater design of the present invention, en masse flow will be achieved by the reciprocating ram movement as long as the geometry of the preheater is in the correct range.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A preheating apparatus for particulate material comprising:
a containment vessel;
a floor to said containment vessel having a center section in which there is a material outlet for discharging preheated particulate material out of the apparatus;
a vertically oriented outer annular preheating section which circles the center section, said annular preheating section having an outer wall and an inner wall, said inner wall having a lower side that is spaced above the floor to form an arch; said annular preheating section being adaptable to having particular material move downward therethrough in counter current relation to the upward flow of preheating gas through said annular preheating section;
a material feeder having a leading pusher face, the feeder being located adjacent to the floor, and being disposed to be reciprocally movable from a first retracted position located closer to the outer wall to a second extended position located between the first retracted position and the material outlet of the chamber for contacting particulate material with said pusher face and moving particulate material toward the material outlet; wherein the ratio L/R is less than or equal to about 2.15, when
L is the straight line distance from (a) a first point located where the leading edge of the pusher face is adjacent to the floor when the pusher ram is in a retracted position to (b) the material outlet, and
R is the straight line distance from said first point to the arch.

2. The preheating apparatus of claim 1 wherein the ratio of L/R is from about 0.25 to about 2.15.

3. The preheating apparatus of claim 2 wherein the ratio of L/R is from about 1.0 to about 2.0.

4. The preheating apparatus of claim 1 wherein the outer wall of the annular preheating section also serves as the outer wall of the containment vessel.

5. The preheating apparatus of claim 1 wherein the floor is essentially horizontal.

6. The preheating apparatus of claim 1 the floor is sloped downwardly toward the material outlet at an angle up to about 8° from the horizontal.
